(19) United States
(12) Patent Application Publication
(10) Pub. No.: US 2018/0045889 A1
(43) Pub. Date: Feb. 15, 2018

(54) METHOD AND SYSTEM FOR POLARIZATION STATE GENERATION

(71) Applicant: PRESIDENT AND FELLOWS OF HARVARD COLLEGE, Cambridge, MA (US)

(72) Inventors: Alan Jenting SHE, Cambridge, MA (US); Federico CAPASSO, Cambridge, MA (US)

(73) Assignee: PRESIDENT AND FELLOWS OF HARVARD COLLEGE, Cambridge, MA (US)

(21) Appl. No.: 15/551,268

(22) PCT Filed: Feb. 3, 2016
(86) PCT No.: PCT/US16/16376

§ 371 Date: Aug. 15, 2017

Related U.S. Application Data
(60) Provisional application No. 62/117,014, filed on Feb. 17, 2015.

(51) Int. Cl. G02B 6/27

(52) U.S. Cl. CPC G02B 6/2766; G02B 6/272; G02B 6/2773

(57) ABSTRACT

An apparatus for polarization state generation and phase control includes a Stokes Basis generator to generate multiple Stokes Bases from one or more input beams, an intensity modulator to modulate an intensity of each of the Stokes Bases, and a beam combiner to combine the modulated Stokes Bases into an output beam. A method of polarization state generation and phase control includes generating multiple Stokes Bases from an input beam; modulating an intensity of each of Stokes Bases; and combining the modulated Stokes Bases into an output beam.

### CROSS-REFERENCE TO RELATED PATENT APPLICATIONS

This application claims the benefit of U.S. Provisional Patent Application 62/117,014 filed Feb. 17, 2015 to She et al., titled “Method and System for Polarization State Generation,” the contents of which are incorporated herein by reference in their entirety.

### STATEMENT REGARDING FEDERALLY SPONSORED RESEARCH OR DEVELOPMENT

This invention was made with Government support under Grant No. N66001-13-1-2007, awarded by the U.S. Navy, Space and Naval Warfare Systems Center Pacific. The Government has certain rights in the invention.

### FIELD OF THE DISCLOSURE

The present disclosure, in general, relates to apparatus and methods for polarization state generation and phase control.

### BACKGROUND

A polarization state generator transforms incoming light into a beam of a desired polarization state. If the generator can produce a beam of any desired polarization state, it is called a complete polarization state generator. It is desirable for a polarization state generator to produce a beam of light with a well-defined state of polarization and phase on demand. Current polarization state generators depend on technologies such as control of optical path length for phase control, indices of refraction and birefringence of optical materials. However, due to the use of moving parts, such as rotating wave plates or bending fibers, current polarization state generators lack stability and repeatability of generated polarization states. Therefore, current techniques for polarization state generation often require additional control systems to compensate for the lack of stability and repeatability of the generated polarization states. In addition, the use of moving parts limits the speed of polarization state generators in changing polarization state. Furthermore, birefringent materials and phase control devices may not easily act on a broad spectrum of wavelengths simultaneously, and moreover may not be readily available in some desired wavelength spectra, such as for an X-ray spectrum or other high-energy electromagnetic radiation spectrum. Cost effective and easy-to-use polarization state generators with improved speed and stability for a broad spectrum of electromagnetic radiation are desired.

### SUMMARY

In an aspect, an apparatus for polarization state generation and phase control includes a Stokes Basis generator to generate multiple Stokes Bases from an input beam, an intensity modulator to modulate an intensity of each of the Stokes Bases, and a beam combiner to combine the modulated Stokes Bases into an output beam.

In an aspect, a method of polarization state generation and phase control includes generating multiple Stokes Bases from an input beam; modulating an intensity of each of Stokes Bases; and combining the modulated Stokes Bases into an output beam.

### BRIEF DESCRIPTION OF DRAWINGS

FIG. 1 illustrates a Poincaré sphere.

FIG. 2 illustrates an example of a tetrahedron inscribed on a Poincaré sphere with four vertices representing Stokes Bases, according to an embodiment of the present disclosure.

FIG. 3 illustrates a high-level schematic of an example of a polarization state generation and phase control device according to an embodiment of the present disclosure.

FIG. 4 illustrates internal functional modules of an example of a polarization state generation and phase control device according to an embodiment of the present disclosure.

FIG. 5 illustrates an example of a device configured to perform intensity modulation of Stokes Bases according to an embodiment of the present disclosure.

FIG. 6 illustrates an example of a device configured to perform intensity modulation of Stokes Bases according to an embodiment of the present disclosure.

FIG. 7A illustrates an example of a device configured to perform intensity modulation of Stokes Bases according to an embodiment of the present disclosure.

FIG. 7B illustrates an example of a digital micromirror device with four regions, each acting as an intensity modulator for one Stokes Basis according to an embodiment of the present disclosure.

FIG. 8 illustrates an example of a coherent Stokes Basis generator according to an embodiment of the present disclosure.

FIG. 9 illustrates an example of a coherent Stokes Basis generator according to an embodiment of the present disclosure.

FIG. 10 illustrates an example of a coherent Stokes Basis generator according to an embodiment of the present disclosure.

FIG. 11 illustrates an example of a beam combiner according to an embodiment of the present disclosure.

FIG. 12 illustrates an example of a beam combiner according to an embodiment of the present disclosure.

FIG. 13 illustrates an example of a polarization state generator according to an embodiment of the present disclosure.

FIG. 14 illustrates an example of a polarization state generator according to an embodiment of the present disclosure.

FIG. 15A illustrates an example of a polarization state generator according to an embodiment of the present disclosure.

FIG. 15B illustrates an example of quadrant modulation displayed on a digital micromirror device surface according to an embodiment of the present disclosure.

FIG. 16A illustrates examples of polarization states generated by the polarization state generator illustrated in FIG. 15A, traced on a Poincaré sphere as the intensity modulator varies the linear combination of pairs of Stokes Bases, according to an embodiment of the present disclosure.

FIG. 16B illustrates an eye diagram of a random bit stream using horizontal and vertical polarization modulation by the polarization state generator illustrated in FIG. 15A.

FIG. 17 illustrates an example of a polarization state generator architecture according to an embodiment of the present disclosure.

FIG. 18 illustrates, by way of a Poincaré sphere, an example of a system with four Stokes Bases having a degenerate state of polarization.

FIG. 19 illustrates, by way of a Poincaré sphere, an example of a system with four Stokes Bases C1, C2, C3, C4 optimized for improved uniformity of state of polarization coverage.

FIG. 20A, FIG. 20B, FIG. 20C and FIG. 20D illustrate experimental data for the Stokes Bases of FIG. 19.

FIG. 21 illustrates an example of a computing device.

Some or all of the figures are schematic representations by way of example; hence, they do not necessarily depict the actual relative size or locations of the components or devices shown. The figures are presented for the purpose of illustrating one or more embodiments with the explicit understanding that they will not be used to limit the scope or the meaning of the claims that follow below.

### DETAILED DESCRIPTION

The following examples and embodiments serve to illustrate the present disclosure. These examples are in no way intended to limit the scope of the disclosure.

The present disclosure provides techniques for polarization state generation and phase control by controlling optical intensity of spatially separated polarization components. Examples of devices using the techniques are further provided. The techniques described allow for polarization state generators with performance at or close to theoretical limits in speed and stability using current technologies of optical intensity modulation, and hence do not depend on a development of other technologies, such as control of optical path length, and indices of refraction or birefringence of optical materials.

As described in the present disclosure, a desired state of polarization (degree of polarization) and phase control are achieved by modulating separated polarization components of one or more input light sources, and combining the modulated and separated polarization components into an output light beam with a desired degree of polarization and phase. The input light source may be, for example, a laser beam, which can be monocoherent, multispectral, or broadband (e.g., a super-continuum laser, or a beam composed of an array of spectrally diverse light sources). The output light beam may be a laser beam. The modulating and/or combining may be performed in an analog or a digital manner.

The modulated separated polarization components may be modulated and prepared for combining in their polarization states in any order (e.g., first by intensity modulation and then by polarization state preparation, or vice versa).

A beam of light with a specific polarization state and phase can be described as in equation (1), where the polarization state is specified by

$$( \begin{matrix}{E}_{x} \\ {E}_{y} {e}^{i θ}\end{matrix} ) ,$$

Eₓ and E_{y} represent the horizontal and vertical polarization components of the electric field of the light wave, and the phase is specified by e^{iφ}.

$$\vec{E} = ( \begin{matrix}{E}_{x} \\ {E}_{y} {e}^{i θ}\end{matrix} ) {e}^{i φ} \qquad ( 1 )$$

If the phase shift θ between Eₓ and E_{y} is 0, the light wave is linearly polarized. A relative amplitude of Eₓ and E_{y} determines an angle of the linear polarization. If there is a phase shift between Eₓ and E_{y}, the light wave is generally elliptically polarized, or circularly polarized if the phase shift is exactly 90°.

A light wave can be described in terms of its total intensity I, degree of polarization p, and shape parameters of the polarization ellipse. An alternative and mathematically convenient description is given by Stokes parameters S₀, S₁, S₂ and S₃. The Stokes parameters S₀, S₁, S₂ and S₃ may also be denoted as I, Q, U and V. Neglecting the first Stokes parameter S₀ (intensity I), the three other Stokes parameters can be plotted directly in three-dimensional Cartesian coordinates. The relationship between the Stokes parameters and the intensity and polarization ellipse parameters can be described as in equations (2), (3), (4) and (5), where I₂, 2ψ and 2χ are spherical coordinates of the polarization state in a three-dimensional space of the Stokes parameters S₁, S₂, and S₃, the three-dimensional space being known as a Poincaré sphere.

S₀=I (2)

S₁=Ip cos 2ψ cos 2χ (3)

S₂=Ip sin 2ψ cos 2χ (4)

S₃=Ip sin 2χ (5)

Equation (6) describes a power P related to the Stokes parameters S₁, S₂ and S₃.

P=\sqrt{S₁²+S₂²+S₃²} (6)

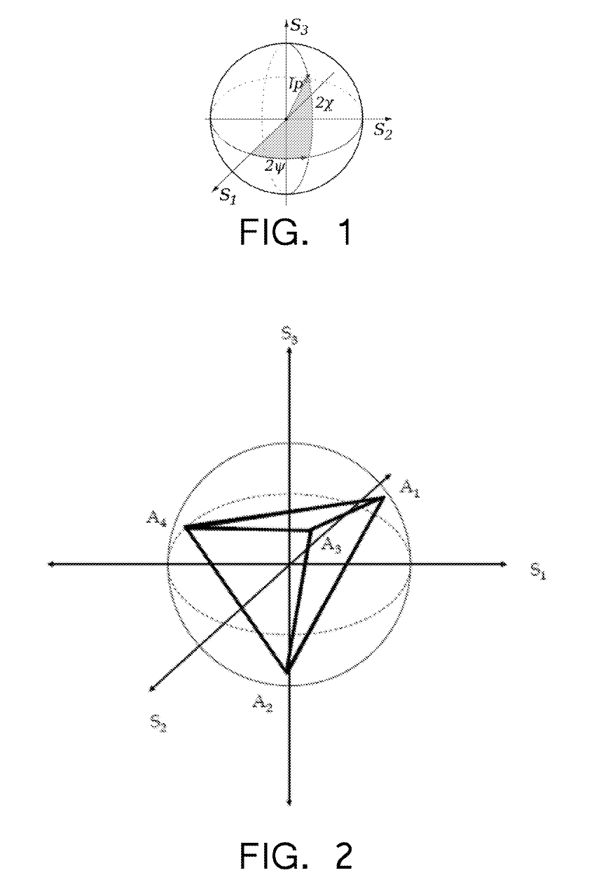

FIG. 1 illustrates a Poincaré sphere of radius P. For a polarized wave with a power given by equation (6), the set of all polarization states can be mapped to points on the surface of the Poincaré sphere of radius P, which then graphically represents the Stokes parameters. The factors of two before ψ and χ in equations (3), (4) and (5) reflect that any polarization ellipse is indistinguishable from another one rotated by 180°, or another one with the semi-axis lengths swapped, accompanied by a 90° rotation.

FIG. 2 illustrates a tetrahedron inscribed in the Poincaré sphere, wherein the four vertices represent four particular polarization states A₁, A₂, A₃ and A₄, where Aₓ is referred to herein as a Stokes Basis. A minimal number of Stokes Bases for full coverage of polarization states on the Poincaré sphere is four. Full coverage of all polarization states on the Poincaré sphere can also be achieved with more than four Stokes Bases, such as five or more, six or more, seven or more, and so forth. There is a constraint that a volume of the tetrahedron inscribed in the Poincaré sphere is greater than zero for full coverage of polarization states on the Poincaré sphere. If full coverage of polarization states in the Poincaré sphere is not desired, a polarization state can be generated with less than four Stokes Bases, such as three or less.

The selected Stokes Bases can be prepared using a optical elements, such as linear polarizers and rotatable retarders, or variable circular polarizers. Some non-limiting examples are provided in the present disclosure.

Four coherent input source beams corresponding to A1, A2, A3 and A4 of FIG. 2 can each represent a Stokes Basis having a specified polarization state and global phase given equation (7), where n ranges from 1 to 4.

$${\vec{A}}_{n} = ( \begin{matrix}{A}_{n , x} \\ {A}_{n , y} {e}^{i {θ}_{n}}\end{matrix} ) {e}^{i {φ}_{n}} \qquad ( 7 )$$

According to equation (7), a light wave with any arbitrary state of polarization and phase can be generated by modulating the intensity of each of the four source beams, which corresponds to modulating a square of the amplitudes of the four source beams, and combining the four modulated coherent source beams such that they are spatially overlapped. Intensity modulation can be achieved as a result of control over one or more optical processes, such as optical absorption, emission (e.g., directly modulated lasers), reflection, diffusion, scattering, deflection, directional coupling, diffraction, and dispersion. Some non-limiting examples are provided in the present disclosure.

Equation (7) can be represented more compactly using complex numbers as shown in equation (8), where the global phase and phase shift e^{iθ} have been included in the complex notation.

$$\vec{A} = ( \begin{matrix}\tilde{{A}_{n , x}} \\ \tilde{{A}_{n , y}}\end{matrix} ) \qquad ( 8 )$$

Amplitude modulation of the Stokes Bases A₁, A₂, A₃ and A₄ can be described with positive coefficients α₁, α₂, α₃ and α₄; thus, a resultant electric field after combination can be described as shown in equation (9).

Ē=α₁A̅₁̅+α₂A̅₂̅+α₃A̅₃̅+α₄A̅₄̅ (9)

Four equations, shown as equations (10), (11), (12) and (13), can be derived by separating the real and imaginary parts of Equation (9).

$$\begin{matrix}{\sum }_{n = 1}^{4} {α}_{n} {A}_{n , x}^{r e} = {E}_{x} cos φ & ( 10 ) \\ {\sum }_{n = 1}^{4} {α}_{n} {A}_{n , x}^{im} = {E}_{x} sin φ & ( 11 ) \\ {\sum }_{n = 1}^{4} {α}_{n} {A}_{n , y}^{r e} = {E}_{y} cos ( θ + φ ) & ( 12 ) \\ {\sum }_{n = 1}^{4} {α}_{n} {A}_{n , y}^{im} = {E}_{y} sin ( θ + φ ) & ( 13 )\end{matrix}$$

The four equations (10), (11), (12) and (13) can be rewritten in a matrix form, as shown in equation (14).

$$( \begin{matrix}{A}_{1 , x}^{re} & {A}_{2 , x}^{re} & {A}_{3 , x}^{re} & {A}_{4 , x}^{re} \\ {A}_{1 , x}^{im} & {A}_{2 , x}^{im} & {A}_{3 , x}^{im} & {A}_{4 , x}^{im} \\ {A}_{1 , y}^{re} & {A}_{2 , y}^{re} & {A}_{3 , y}^{re} & {A}_{4 , y}^{re} \\ {A}_{1 , y}^{im} & {A}_{2 , y}^{im} & {A}_{3 , y}^{im} & {A}_{4 , y}^{im}\end{matrix} ) ( \begin{matrix}{a}_{1} \\ {a}_{2} \\ {a}_{3} \\ {a}_{4}\end{matrix} ) = ( \begin{matrix}{E}_{x} cos φ \\ {E}_{x} sin φ \\ {E}_{y} cos ( θ + φ ) \\ {E}_{y} sin ( θ + φ )\end{matrix} ) \qquad ( 14 )$$

By solving matrix equation (14) to find the desired value of α₁, α₂, α₃ and α₄, and modulating each input source beam accordingly, a beam of light with a specific polarization state θ and phase φ can be generated.

One way to solve matrix equation (14) such that α₁, α₂, α₃ and α₄ are positive is by treating it as a non-negative least square curve fitting problem. Equation (14) can be rewritten as shown in equation (15).

A·α=E (15)

Then, α₁, α₂, α₃ and α₄ can be solved by minimizing equation (16), where α₁, α₂, α₃ and α₄ are each greater than zero.

min∥A·α−E∥ (16)

Equation (16) can be solved efficiently using a computing device.

Once the intensity (or amplitude) modulation of each Stokes Basis is known, the required intensity modulation can be provided to a device that performs intensity modulation of the input source beams.

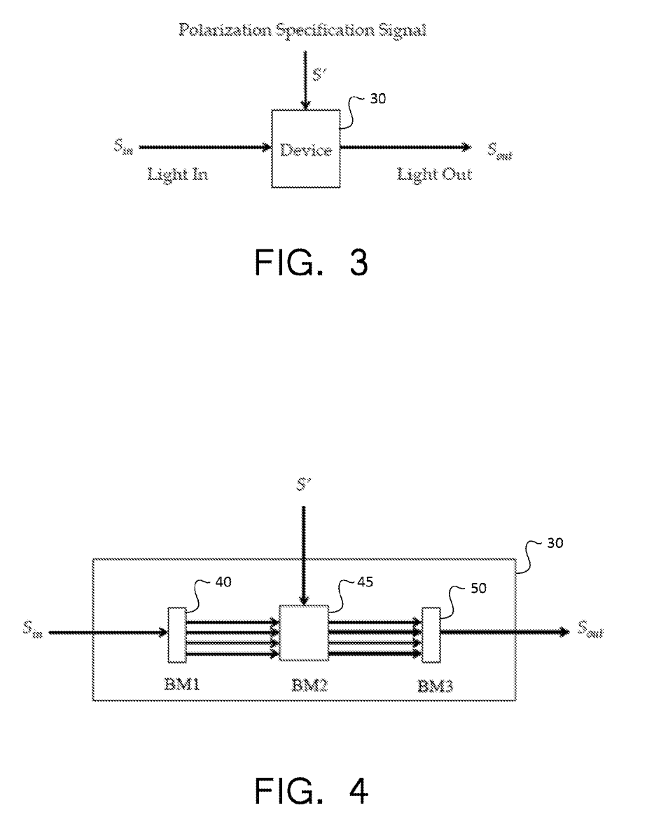

FIG. 3 illustrates a high-level structure of a polarization state generator 30. As illustrated, an input light beam Sᵢₙ is provided to the polarization state generator 30, which is controlled by a control signal S′ to generate an output light beam Sₒᵤₜ of desired state of polarization and phase. The control signal S′ in some embodiments is one or more signals provided by a computing device.

FIG. 4 illustrates internal functional modules of an embodiment of the polarization state generator 30 of FIG. 3. The device comprises three modules: (1) a beam splitter/preparer 40 (BM1), (2) an intensity modulator 45 (BM2), and (3) a beam combiner 50 (BM3). In some embodiments, a computing device controls configuration of one or more of BM1, BM2 or BM3.

As shown by way of example in FIG. 4, in some embodiments, input light beam Sᵢₙ is split into four coherent beams in the beam splitter/preparer BM1, each being prepared as one of four Stokes Bases. These four beams are individually modulated in intensity by the control signal S′ in the intensity modulator BM2, and then combined in the beam combiner BM3 to form the output light wave Sₒᵤₜ with the desired polarization state. As noted above, the input light wave Sᵢₙ may be split and prepared into 5 or more coherent Stokes Bases. In some embodiments, the input light wave Sᵢₙ may be split and prepared into 3 or less Stokes Bases.

In some embodiments, the Stokes Bases are prepared with substantially equal intensity before entering the intensity modulator BM2 such that the intensity modulator BM2 can be omitted, or such that the intensity modulator BM2 can perform independently of the beam splitter/preparer BM1. In some embodiments, intensity values (or other values) can be deemed to be substantially equal if a difference between a largest one of the values and a smallest one of the values is less than or equal to ±10% of the smallest value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Intensity modulation of Stokes Bases can be performed by a variety of techniques, including but not limited to techniques described in the present disclosure.

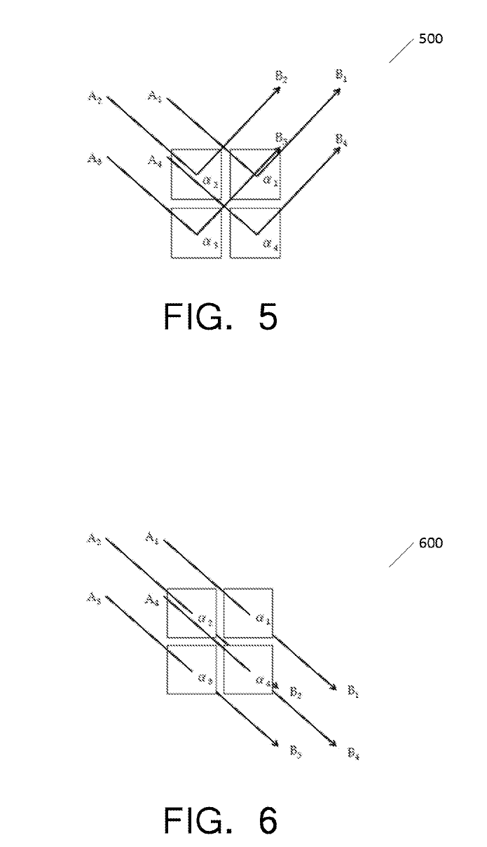

FIG. 5 illustrates an embodiment of a device 500 configured to perform intensity modulation of Stokes Bases by reflection. Device 500 includes four quadrants. Each quadrant modulates the intensity of one of the four Stokes Bases A₁, A₂, A₃ and A₄ by reflective coefficients of α₁, α₂, α₃ and α₄, respectively. Reflected output beams B1, B2, B3 and B4 each have a desired amplitude, phase and state of polarization.

FIG. 6 illustrates an embodiment of a device 600 configured to perform intensity modulation of Stokes Bases through transmission. Device 600 includes four quadrants. Each quadrant modulates the intensity of one of the four Stokes Bases A₁, A₂, A₃ and A₄ by transmissive coefficients of α₁, α₂, α₃ and α₄, respectively. Transmitted output beams B1, B2, B3 and B4 each have a desired amplitude, phase and state of polarization.

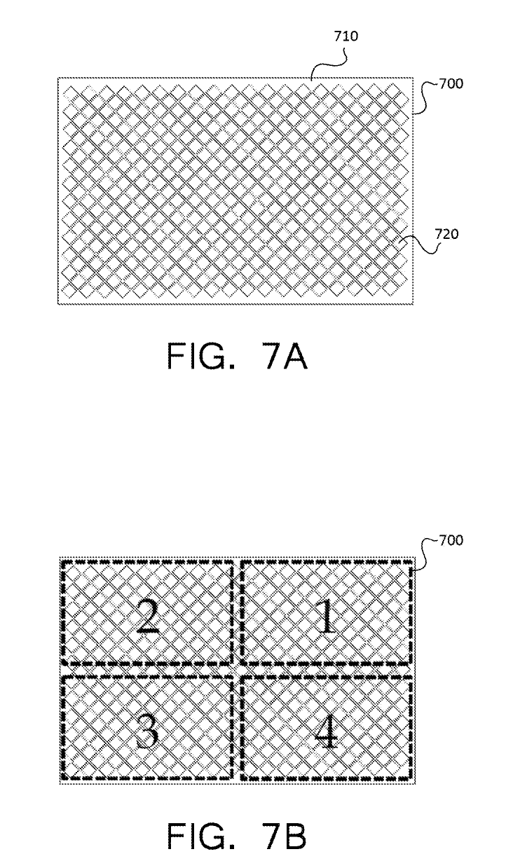

FIG. 7A illustrates an embodiment of a device 700 capable of performing intensity modulation of Stokes Bases by reflection, in the form of a digital micromirror device (DMD) chip 710. As illustrated, the DMD chip 710 includes many (e.g., hundreds or thousands) of microscopic mirrors 720 arranged in an array (e.g., a rectangular array as shown in FIG. 7A) on a surface of the DMD chip 710. The microscopic mirrors 720 can be individually rotated by certain angle, such as, for example, within about ±10° to about ±12° of a desired angle. In an “on” state, incident light is reflected at the desired angle. In the “off” state, incident light is directed elsewhere, for example, to a heat sink. In some embodiments, an intensity of a total reflected beam (a combined output of the microscopic mirrors 720) can be modulated by turning “on” different numbers of microscopic mirrors 720. In some embodiments, the intensity of the reflected beam can be modulated by turning “on” and “off” different numbers of microscopic mirrors 720 with different “on” time to “off” time ratios. Each microscopic mirror 720 can be controlled individually, and/or a group of microscopic mirrors 720 may be controlled as a group. Control of the microscopic mirrors 720 may be by a computing device.

FIG. 7B illustrates a DMD chip 700 organized into four regions by design or by control, each region acting as an intensity modulator for one Stokes Basis. Each of the four regions can include many (e.g., hundreds or thousands) of microscopic mirrors 720. Although shown in FIG. 7A as approximately equal-area rectangles, in other embodiments, the regions may have a different shape than a rectangle, and each region may have a shape different than other regions.

The DMD chip 700 (e.g., as shown in FIG. 7B) may be used to implement the reflective intensity modulation of device 500 of FIG. 5. It should be noted that other types of arrays may be used to implement the transmissive intensity modulation of device 600 of FIG. 6 by controlling individual components or groups of components in an array of transmissive components.

Referring again to FIG. 4, with respect to the beam splitter/preparer BM1 prior to intensity modulation in the intensity modulator BM2, coherent Stokes Bases may be generated by a variety of techniques, including but not limited to the techniques described in the present disclosure.

FIG. 8 illustrates an embodiment of the beam splitter/preparer BM1 described in FIG. 4, for generation of coherent Stokes Bases using multiple knife-edge reflectors 810 of substantially equal size. The knife-edge reflectors 810 are offset from each other horizontally and vertically (in the orientation shown). Due to the offsets, the input beam Sᵢₙ is split into multiple output beams 820, the number of which is determined by the number of knife-edge reflectors 810 being illuminated by the input beam Sᵢₙ. In the embodiment illustrate in FIG. 8, each knife-edge reflector 820 reflects (as output bean 820) a substantially equal portion of the input beam Sᵢₙ. The offsets of the knife-edge reflectors 810 also create different delays, and therefore different phases, of the output beams 820 due to different propagation lengths of the paths. A diversion angle ‘a’ between the input light beam Sᵢₙ and the output beams 820 depends on an incident angle of the input light beam Sᵢₙ on the reflecting surfaces of the knife-edge reflectors 810. In the embodiment of FIG. 8, the diversion angle ‘a’ is about 90°. In other embodiments, other diversion angles are implemented. Each output beam 820 can be converted to a Stokes Basis beam with defined polarization using a polarizer 830 (e.g., a linear polarizer or a circular polarizer). Each polarizer 830 can be an absorptive polarizer, beam-splitting polarizer, reflective polarizer, birefringent polarizer, thin film polarizer, or other type of polarizer, and a different type of polarizer 830 may be used for each output beam 820.

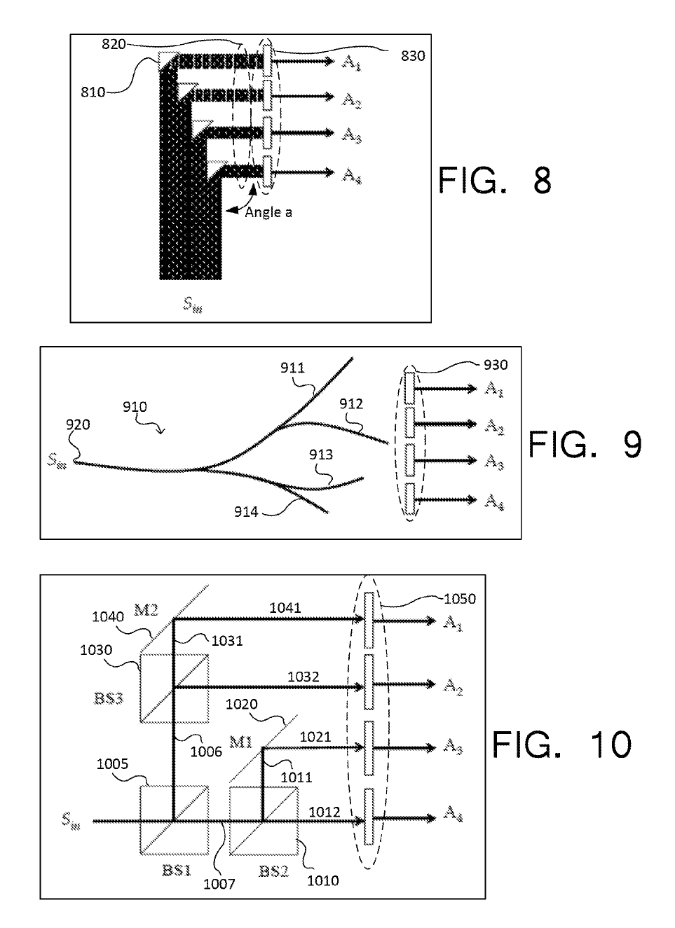

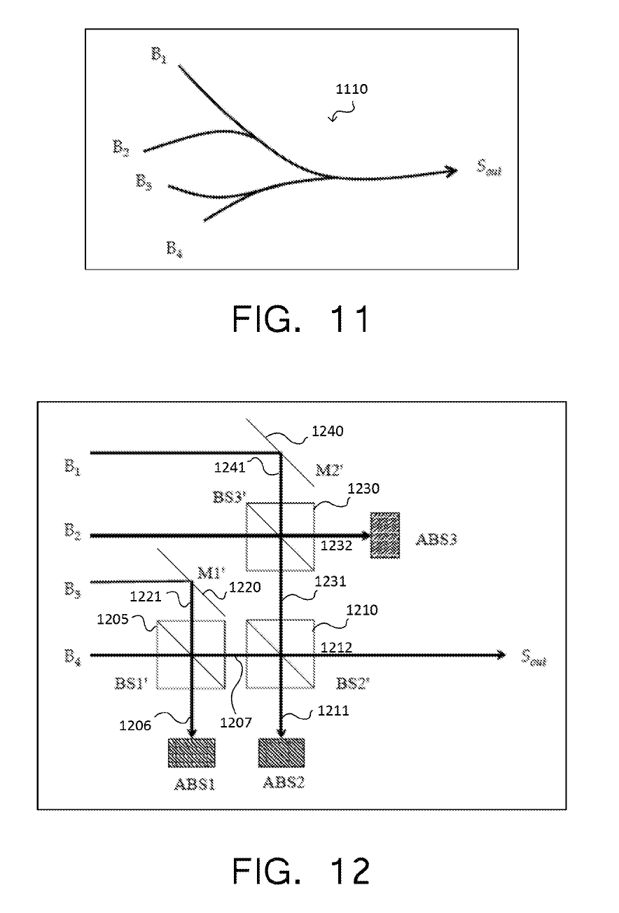

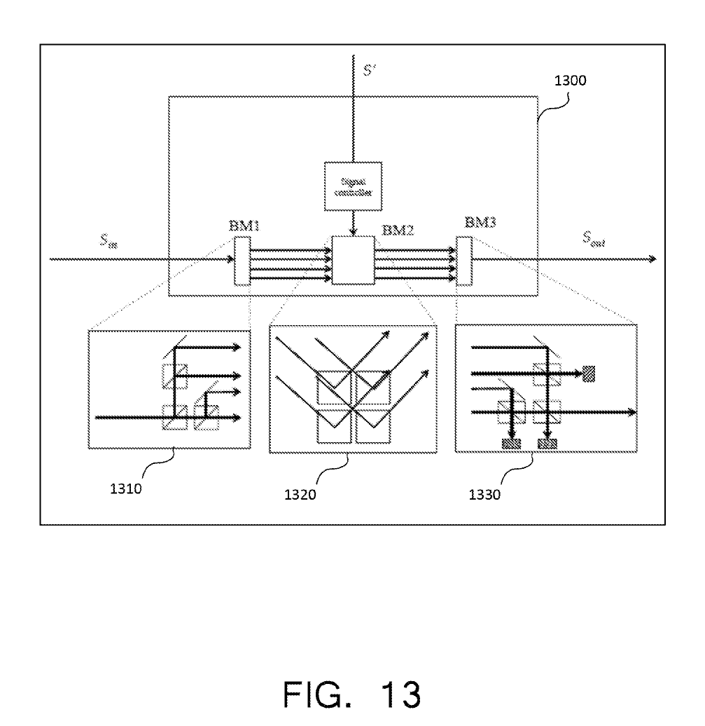

FIG. 9 illustrates an embodiment of the beam splitter/preparer BM1 described in FIG. 4, for generation of coherent Stokes Bases using a fiber optic beam splitter 910. The fiber optic beam splitter 910 can be, for example, a fused biconical taper splitter, a waveguide planar lightwave circuit splitter, or other beam splitters coupled and integrated with optical fibers. An input beam Sᵢₙ is coupled to an input 920 of the beam splitter 910. Each output of the beam splitter is provided by an output fiber (e.g., output fibers 911, 912, 913, 914). The propagation paths of the outputs may be of different lengths, thus creating different delays and phases in each output beam. The output beams of the beam splitter can each be converted to a Stokes Basis beam with defined polarization using a polarizer 930, similarly as described above with respect to polarizers 830. In some embodiments, the polarizer 930 may be a fiber optic polarizer or other integrated optical polarizer.

FIG. 10 illustrates an embodiment of the beam splitter/preparer BM1 described in FIG. 4, for generation of coherent Stokes Bases using bulk beam splitters (e.g., BS1, BS2 and BS3) and mirrors (e.g., mirrors M1 and M2). In some embodiments, a bulk beam splitter is a cube made from two triangular glass prisms glued or otherwise combined together. An interface of the two prisms is designed such that a portion of an incident light beam is reflected and another portion of the incident light beam is transmitted, such as by frustrated total internal reflection or birefringent polarization beam splitting. In some embodiments, the reflected light and the transmitted light are of substantially equal intensity.

As illustrated in the embodiment of FIG. 10, the input beam Sᵢₙ is split into a reflected beam 1006 and a transmitted beam 1007 by a beam splitter 1005 (BS1). The transmitted beam 1007 is split into a reflected beam 1011 and a transmitted beam 1012 by a beam splitter 1010 (BS2). The reflected beam 1011 is then reflected as a reflected beam 1021 by a mirror 1020 (M1). The reflected beam 1006 from the beam splitter BS1 is split into a reflected beam 1031 and a transmitted beam 1032 by a beam splitter 1030 (BS3). The transmitted beam 1032 is reflected as a reflected beam 1041 by a mirror 1040 (M2). As a result, input beam Sᵢₙ is split into four beams, the transmitted beam 1012, the reflected beam 1021, the transmitted beam 1032, and the reflected beam 1041 by the beam splitter/preparer of FIG. 10. Each of these four beams can then be converted to a Stokes Basis beam with defined polarization using a polarizer 1050, similarly as described above with respect to polarizers 830.

In some embodiments, the bulk beam splitter may incorporate one or more half-silvered mirrors for reflection and transmission (e.g., as the beam splitter BS1, BS2 or BS3).

Referring again to FIG. 4, with respect to the beam combiner BM3, a combination beam may be generated by a variety of techniques, including but not limited to the techniques described in the present disclosure. The beam combiner BM3 combines output beams of the intensity modulator BM2 (e.g., the output beams B₁, B₂, B₃ and B₄ illustrated in FIG. 5 or FIG. 6) such that the output beams are spatially overlapped.

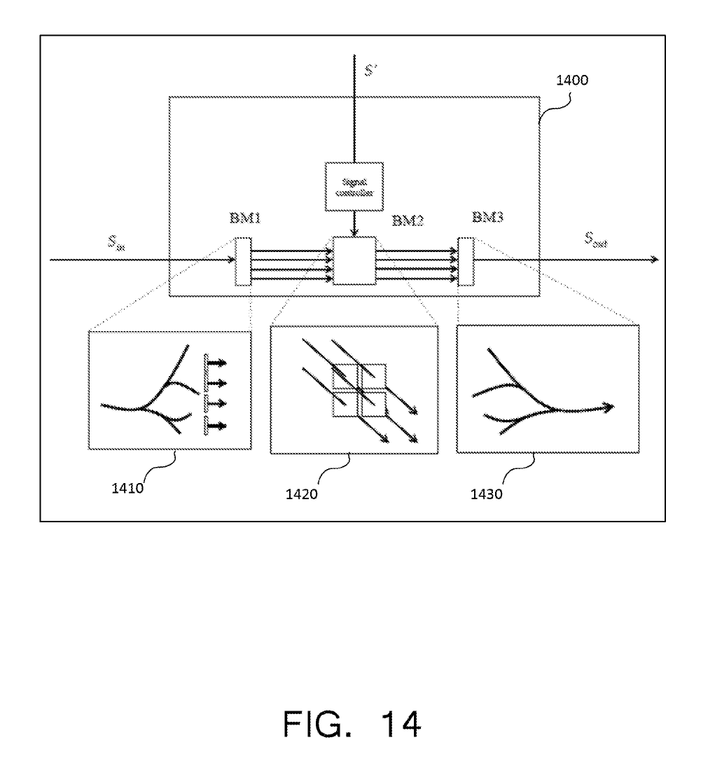

FIG. 11 illustrates an embodiment of the beam combiner BM3 of FIG. 4. In the embodiment illustrated in FIG. 11, fiber optic power splitters are used in a reverse direction to form a beam combiner 1110. Output beams B₁, B₂, B₃ and B₄ from an intensity modulator (e.g., the output beams B₁, B₂, B₃ and B₄ of the intensity modulators 500 or 600 respectively illustrated in FIG. 5 or FIG. 6) are provided as inputs to the beam combiner 1110 of FIG. 11. The fiber optic power splitter 1110 illustrated in FIG. 11 can be the same as or similar to the fiber optic power splitter 910 illustrated in FIG. 9. A combined beam Sₒᵤₜ is output by the beam combiner 1110.

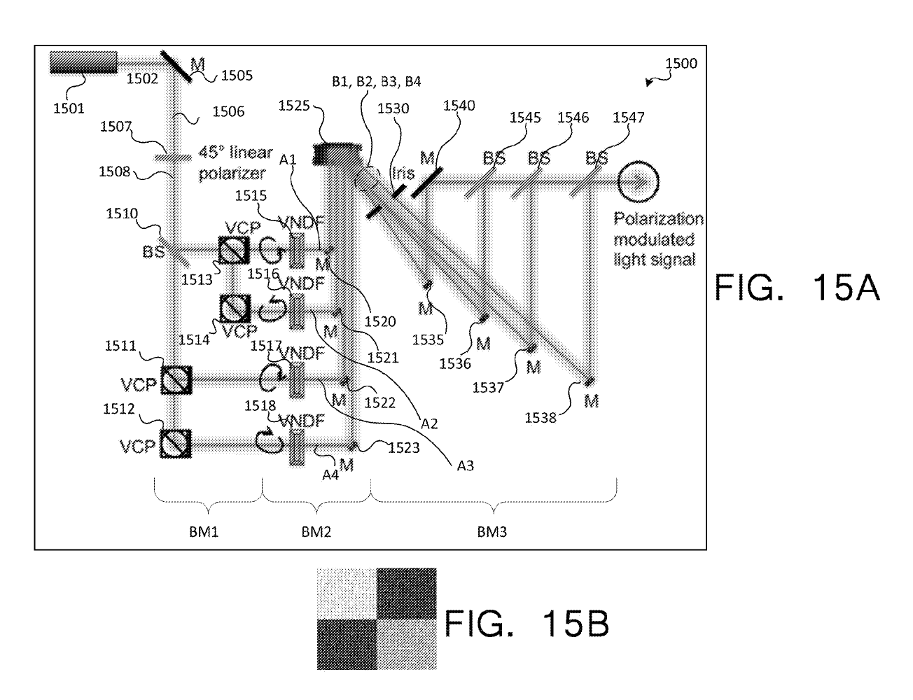

FIG. 12 illustrates an embodiment of the beam combiner BM3 of FIG. 4. In the embodiment illustrated in FIG. 12, non-polarizing beam splitters (e.g., BS1′, BS2′ and BS3′) are used with mirrors (e.g., M1′ and M2′) to form a beam combiner. Output beams B₁, B₂, B₃ and B₄ from an intensity modulator (e.g., the output beams B₁, B₂, B₃ and B₄ of the intensity modulators 500 or 600 respectively illustrated in FIG. 5 or FIG. 6) are provided as inputs to the beam combiner of FIG. 12.

As illustrated in the embodiment of FIG. 12, beam B₃ is reflected as a reflected beam 1221 by a mirror 1220 (M1′), and the reflected beam 1221 is partially reflected by a beam splitter 1205 (BS1′) and the partially reflected portion of the reflected beam 1221 is combined with a portion of the beam B₄ transmitted by the beam splitter BS1′ into a transmitted beam 1207. The reflected beam 1221 is partially transmitted by the beam splitter BS1′, and the partially transmitted portion of the reflected beam 1221 is combined with a portion of the beam B₄ reflected by the beam splitter BS1′ into a reflected beam 1206, which is directed to an absorber ABS1.

The beam B₁ is reflected as a reflected beam 1241 by a mirror 1240 (M2′), and the reflected beam 1241 is partially reflected by a beam splitter 1230 (BS3′) and the partially reflected portion of the reflected beam 1241 is combined with a portion of the beam B₂ transmitted by the beam splitter BS3′ into a transmitted beam 1232. The reflected beam 1241 is partially transmitted by the beam splitter BS3′, and the partially transmitted portion of the reflected beam 1241 is combined with a portion of the beam B₂ reflected by the beam splitter BS3′ into a reflected beam 1231, which is directed to a beam splitter 1210 (BS2′).

The reflected beam 1241 is partially reflected by the beam splitter BS3′ and the partially reflected portion of the reflected beam 1241 is combined with a portion of the beam B₄ transmitted by the beam splitter BS3′ into a transmitted beam 1232, which is directed to an absorber ABS3.

The transmitted beam 1207 is partially reflected by the beam splitter BS2′, and is combined with a portion of the reflected beam 1231 transmitted by the beam splitter BS2′ into a reflected beam 1211, which is directed to an absorber ABS2. The transmitted beam 1207 is partially transmitted by the beam splitter BS2′, and is combined with a portion of the reflected beam 1231 reflected by the beam splitter BS2′ into a transmitted beam 1212, which is an output Sₒᵤₜ of the beam combiner. As a result, the four beams B₁, B₂, B₃ and B₄ are combined into a single output Sₒᵤₜ.

A portion of beam B4 is transmitted through a beam splitter BS1′, and another portion of the output beam B4 is reflected by the beam splitter BS1′ to a light absorber ABS1. A portion of an output beam B3 from the intensity modulator (BM2) is reflected by a mirror M1′ and also by the beam splitter BS1′, and is combined with the transmitted portion of the output beam B4. Another portion of the output beam B3 is transmitted through the beam splitter BS1′ to the light absorber ABS1. The combined beam of output beams B3 and B4 after the beam splitter BS1′ is partially transmitted through a beam splitter BS2′ to form a part of the output beam Sₒᵤₜ, and is partially reflected to a light absorber ABS2. A portion of an output beam B2 from the intensity modulator (BM2) is transmitted through a beam splitter BS3′ and is absorbed by a light absorber ABS3; another portion of the output beam B2 is reflected by the beam splitter BS3′ towards the beam splitter BS2′. A portion of an output beam B1 from the intensity modulator (BM2) is reflected by a mirror M2′, is further reflected by the beam splitter BS3′ and is absorbed by the light absorber ABS3; another portion of the output beam B1 is transmitted through the beam splitter BS3′ and is combined with the reflected portion of the output beam B2. The combined beam of output beams B1 and B2 after the beam splitter BS3′ is partially reflected by the beam splitter BS2′ to form another part of the output beam Sₒᵤₜ, and is partially transmitted through the beam splitter BS2′ towards the light absorber ABS2. The output beam Sₒᵤₜ thus comprises a portion of each of the output beams B1, B2, B3 and B4 from the intensity modulator (BM2).

In some embodiments, the polarization state generator disclosed herein has an accuracy of polarization generation of better than about 1°, better than about 0.5°, better than about 0.2°, better than about 0.1°, better than about 0.05°, or better than about 0.01°. In some embodiments, the polarization state generator disclosed herein has a repeatability of polarization generation of better than about 1°, better than about 0.5°, better than about 0.2°, better than about 0.1°, better than about 0.05°, or better than about 0.01°.

The polarization state generator disclosed herein can be used for polarization modulation in optical communication. For example, polarization state generators may be used for polarization modulation in polarization-division multiplexing (PDM), which can be used together with phase modulation, optical quadrature amplitude modulation (QAM) or other advanced coding techniques, allowing transmission speeds of about 100 Gigabit per second or more using a single wavelength. Sets of polarization-division multiplexed wavelength signals can then be carried over a wavelength-division multiplexing (WDM) infrastructure to substantially expand its capacity.

The polarization state generator disclosed herein can also be used in polarization analysis, spectropolarimetry, spectral ellipsometry, swept-wavelength measurement, and monitoring of polarization-related parameters and signal-to-noise ratios of optical networks. The polarization state generator disclosed herein can also be used in other technology areas, such as chemistry, biology or astronomy.

Having described the individual techniques of the present disclosure, some examples are next provided of polarization state generation and phase control devices.

### EXAMPLES

### Example 1

FIG. 13 illustrates an example of an embodiment of a polarization state generation and phase control device according to the structure illustrated in FIG. 4 (reproduced in FIG. 13 as structure 1300). In the embodiment illustrated in FIG. 13, the beam splitter/preparer BM1 for Stokes Bases generation is implemented using bulk beam splitters and mirrors as illustrated and described with respect to FIG. 10 (represented as beam splitter/preparer 1310 in FIG. 13). The intensity modulator BM2 is implemented as a reflective DMD as illustrated and described with respect to FIG. 5 (represented as intensity modulator 1320 in FIG. 13). The beam combiner BM3 is implemented using bulk beam splitters, mirrors and light absorbers as illustrated and described with respect to FIG. 12 (represented as beam combiner 1330 in FIG. 13).

### Example 2

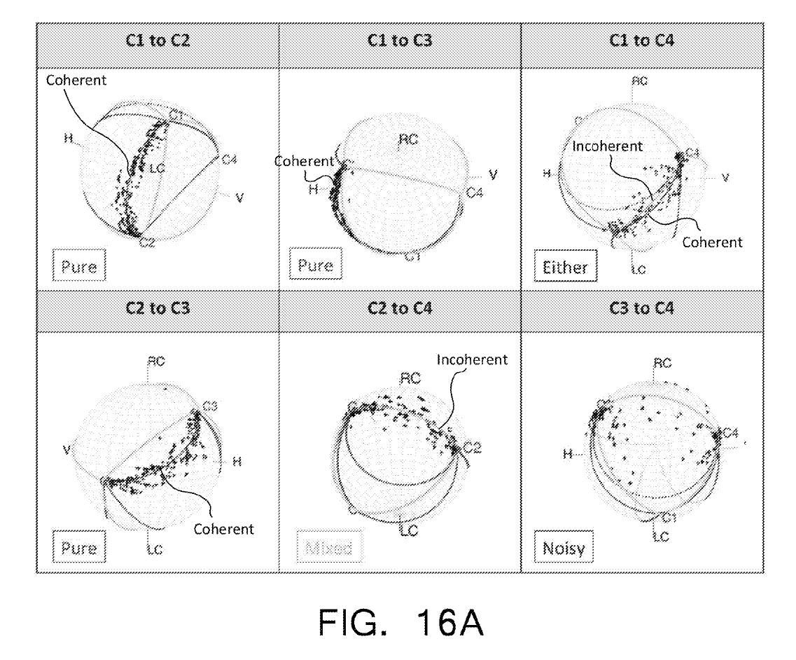

FIG. 14 illustrates an example of an embodiment of a polarization state generation and phase control device according to the structure illustrated in FIG. 4 (reproduced in FIG. 13 as structure 1400). In the embodiment illustrated in FIG. 14, the beam splitter/preparer BM1 for Stokes Bases generation is a fiber or waveguide power splitter as illustrated and described with respect to FIG. 9 (represented as beam splitter/preparer 1410 in FIG. 14). The intensity modulator BM2 is a transmissive intensity modulator as illustrated and described with respect to FIG. 6 (represented as intensity modulator 1420 in FIG. 14). The beam combiner BM3 is a fiber or waveguide power splitter used in reverse direction as illustrated and described with respect to FIG. 11 (represented as beam combiner 1340 in FIG. 14).

### Example 3

FIG. 15A illustrates an example of an embodiment of a polarization state generation and phase control device according to the structure illustrated in FIG. 4. In the embodiment illustrated in FIG. 15A, a light beam 1502 generated by a light source 1501 (e.g., a He—Ne laser) is reflected by a mirror 1505, and the reflected beam 1506 is passed through a 45° linear polarizer 1507 to set an initial polarization state of beam 1508 to a known state. The linearly polarized beam 1508 may be the input Sᵢₙ illustrated in FIG. 4.

The linearly polarized beam 1508 is split into four beams A₁, A₂, A₃ and A₄ through a beam splitter (BS) 1510 and four variable circular polarizers (VCPs) 1511, 1512, 1513, 1514. The BS 1510 and the VCPs 1511, 1512, 1513, 1514 together form a beam splitter/preparer (BM1 in FIG. 4).

The intensities of the four beams A₁, A₂, A₃ and A₄ are equalized by four variable neutral density filters (VNDFs) 1515, 1516, 1517, 1518, respectively, and output as four spatially-separated beams which are then reflected by a respective mirror 1520, 1521, 1522, 1523 labeled ‘M’ (e.g., in an array of mirrors) to a modulator 1525. The four spatially-separated beams are modulated by the modulator 1525 and output as beams B₁, B₂, B₃ and B₄. In an embodiment, a DMD device (e.g., a Texas Instruments DMD device DLP3000) is used as the modulator 1525, and the four spatially-separated beams strike four quadrants on the surface of the DMD and are reflected off the DMD after modulation. The VNDFs and the DMD together from an intensity modulator (BM2 in FIG. 4).

The four beams A₁, A₂, A₃ and A₄ in this embodiment are the Stokes Bases prior to modulation, and the four output beams B₁, B₂, B₃ and B₄ are the modulated Stokes Bases. An iris 1530 selects the strongest diffraction order of each of the four output beams B₁, B₂, B₃ and B₄.

The four beams B₁, B₂, B₃ and B₄ are recombined using mirrors 1535, 1536, 1537, 1538 and 1540 and beams splitters 1545, 1546, 1547, to generate a single polarized, modulated light beam output Sₒᵤₜ with a desired state of polarization or degree of polarization. The mirrors and beam splitters together form a beam combiner (BM3 in FIG. 4).

FIG. 15B illustrates an example of four-quadrant modulation displayed on a DMD surface.

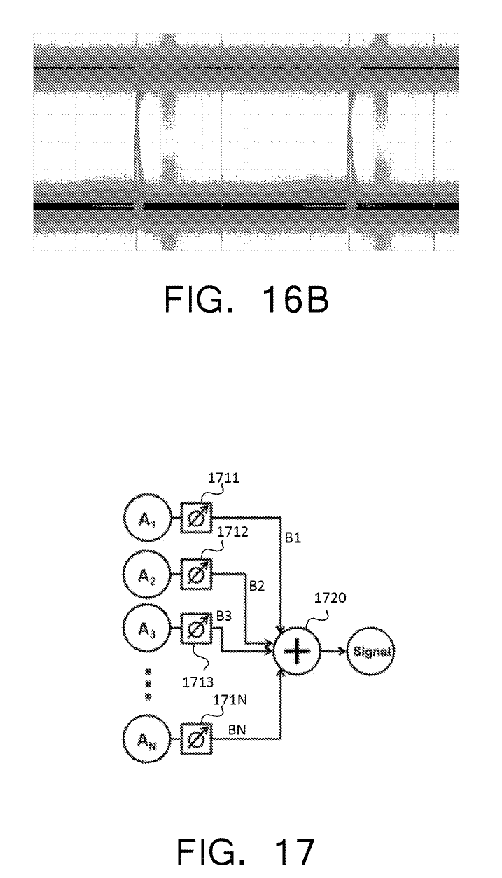

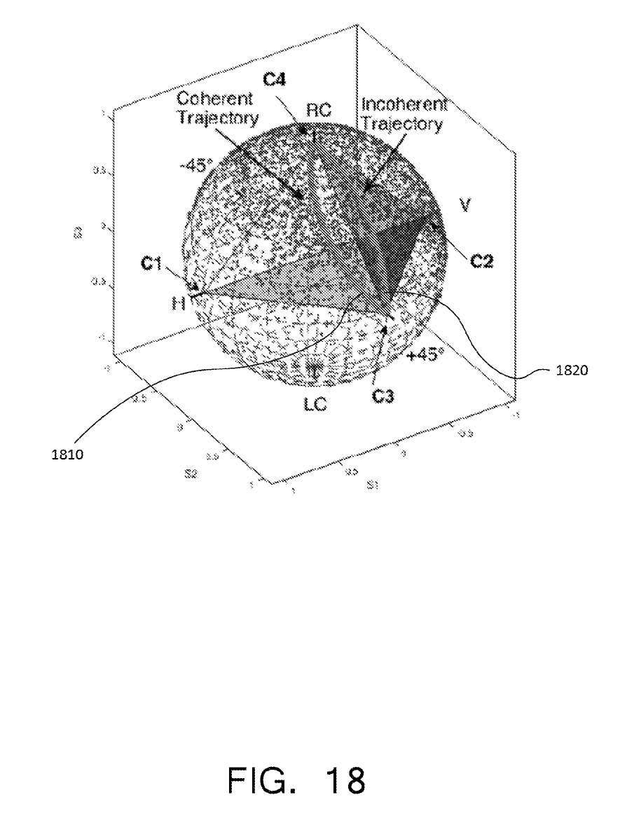

FIG. 16A illustrates polarization states generated by the polarization state generator illustrated in FIG. 15A, traced on a Poincaré sphere as the intensity modulator varies a linear combination of pairs of Stokes Bases. A trajectory is measured by a polarimeter, and the data are plotted. The Stokes Bases are labeled C1-C4. Polarization trajectories are generated by coherent combination and incoherent combination as indicated. A polarization trajectory is generated by coherent combination by maintaining an optical path length between the two Stokes Bases C2 and C3 well below the coherence length of the laser (approximately 20 cm). An incoherent polarization trajectory following the geodesic path between Stokes Bases C2 and C4 is generated by making the optical path length between Stokes Bases much longer than the coherence length of the laser (hence reducing the mutual coherence).

FIG. 16B illustrates an eye diagram of a bit stream using horizontal and vertical polarization modulation by the polarization state generator illustrated in FIG. 15A, where the bit stream is a random bit stream at 4 kilohertz.

### Example 4

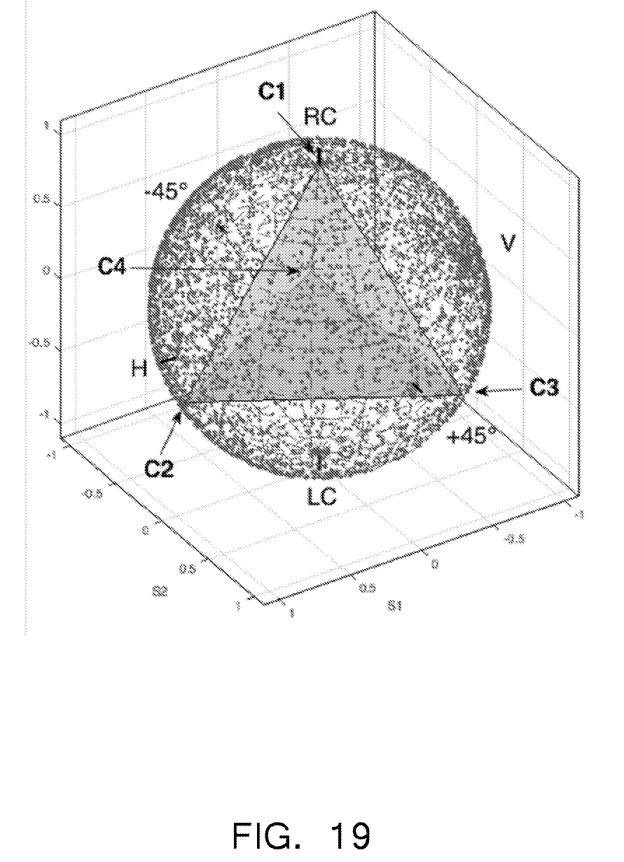

FIG. 17 illustrates an example of a polarization state generator architecture, in which a number N of light sources (A₁, A₂, A₃ . . . A_{N}) with well-defined states of polarization and relative phase (representing a number N of Stokes Bases) are provided to respective modulators 1711, 1712, 1713 . . . 171N. Output beams B₁, B₂, B₃ . . . B_{N} from respective modulators 1711, 1712, 1713 . . . 171N are combined by weighted linear superposition at a beam combiner 1720 to produce a desired output signal Sₒᵤₜ.

### Example 5

FIG. 18 illustrates, by way of a Poincaré sphere, an example of a system with four Stokes Bases C1, C2, C3, C4 having a degenerate state of polarization. The four states of polarization in the system are linear horizontal (C1), vertical (C2), +45° with a 180° phase shift (C3), and right circular polarization (C4). A Monte Carlo simulation was performed (results shown by the dots) by randomly varying intensity modulation parameters. As can be seen, the results show relatively complete, yet non-uniform coverage of states of polarization over the Poincaré sphere. A polarization trajectory between Stokes Bases C3 to C4 is shown for coherent combination (line 1810) and incoherent combination (line 1820). Incoherent trajectories are geodesics.

### Example 6

FIG. 19 illustrates, by way of a Poincaré sphere, an example of a system with four Stokes Bases C1, C2, C3, C4 optimized for improved uniformity of state of polarization coverage. With comparison to the degenerate Stokes Bases system described by FIG. 18, the Stokes Bases C1, C2, C3, C4 of FIG. 19 are vertices of a regular tetrahedron inscribed in the Poincaré sphere. In Jones vector notation, the Stokes Bases C1, C2, C3, C4 or FIG. 19 are respectively [0.7071, 0.7071i], [−9.856, 0.1691i], [0.5141, 0.7941−0.3242i], and [0.5141, −0.7941−0.3242i].

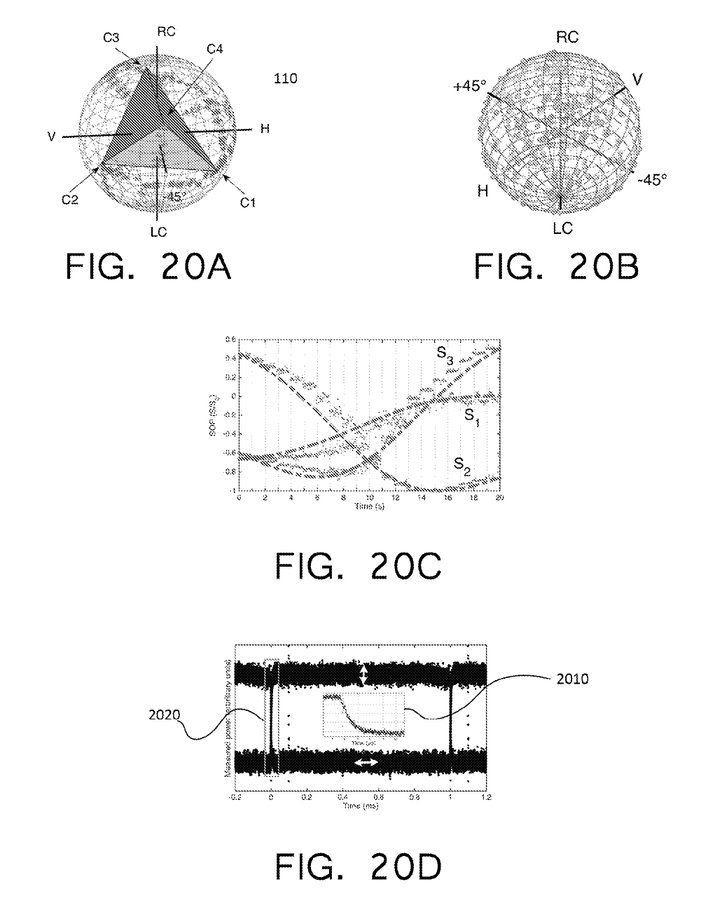

FIGS. 20A-20D illustrate experimental data for the Stokes Bases C1, C2, C3, C4 of FIG. 19 using the polarization state generation and phase control device of FIG. 15A. The Stokes Bases are set to states of polarization approximating (within the error of tuning the VCPs) a regular tetrahedron on the Poincaré sphere. The Stokes Bases C1, C2, C3, and C4 were measured and the resulting tetrahedron drawn (FIG. 20A). Coherent polarization trajectories from each Stokes Basis to every other Stokes Basis were generated by modulating Stokes Bases intensities in twenty discrete increments spanning twenty seconds, and the raw data as measured by a polarimeter are shown (FIG. 20A). A Monte Carlo experiment was performed in which 200 random intensity modulation parameters α were used. The results are shown on a Poincaré sphere (FIG. 20B), indicating good uniformity of coverage of the states of polarization.

FIG. 20C plots time series data (dots on the plot) of a coherent polarization trajectory between Stokes Bases C2 and C4 (of FIG. 20A) against theoretical calculations (dotted lines on the plot), and show good agreement, where S1, S2 and S3 are elements of the Stokes vector.

FIG. 20D is an eye pattern generated for a polarization signal that switches between linear horizontal and vertical polarizations using a DLP3000 DMD device. The data are shown for a pseudorandom bitstream modulated at 1 kHz. The inset 2010 is an enlarged view of the rectangle 2020, showing a measured settling time (eye rise and fall time) to be 3.5 microseconds (μs), following an exponential path.

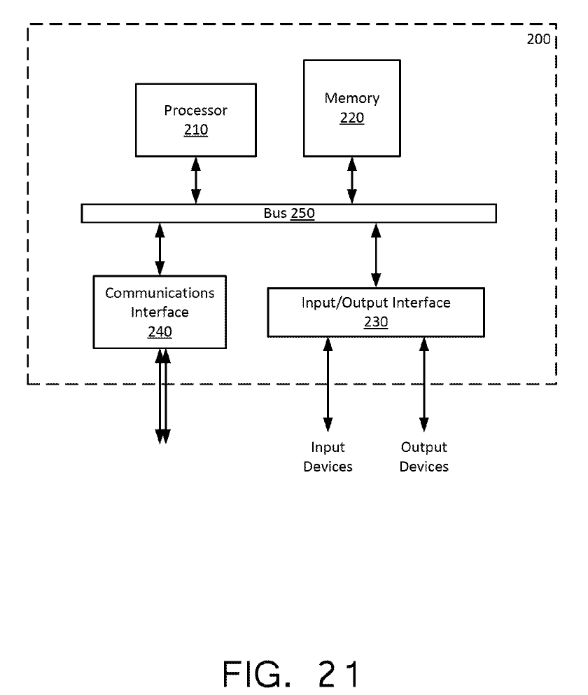

FIG. 21 illustrates an example of a computing device 200, such as may be used to control components in a polarization signal generation system according to an embodiment of the present disclosure. Computing device 200 that includes a processor 210, a memory 220, an input/output interface 230, and a communication interface 240. A bus 250 provides a communication path between two or more of the components of computing device 200. The components shown are provided by way of illustration and are not limiting. Computing device 200 may have additional or fewer components, or multiple of the same component.

Processor 210 represents a programmable processor, which may be, for example, a general-purpose processor, digital signal processor, microprocessor, microcontroller, application specific integrated circuit (ASIC), field programmable gate array (FPGA), other circuitry effecting processor functionality, or multiple ones or combinations of the foregoing, along with associated logic and interface circuitry. Processor 210 may be incorporated in a system on a chip.

Computing device 200 may include code that creates an execution environment for a computer program, such as code that constitutes processor firmware, a protocol stack, a database management system, an operating system, a cross-platform runtime environment, a virtual machine, or a combination of one or more of the foregoing.

A computer program (also known as a program, software, software application, script, instructions or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a network.

Memory 220 represents one or both of volatile and non-volatile memory for storing information (e.g., instructions and data). Examples of memory include semiconductor memory devices such as EPROM, EEPROM, flash memory, RAM, or ROM devices, magnetic media such as internal hard disks or removable disks or magnetic tape, magneto-optical disks, CD-ROM and DVD-ROM disks, holographic disks, and the like.

Portions of controlling a polarization signal generation system may be implemented as computer-readable instructions in memory 220 of computing device 200, executed by processor 210.

An embodiment of the disclosure relates to a non-transitory computer-readable storage medium (e.g., memory 220) having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the embodiments of the disclosure, or they may be of the kind well known and available to those having skill in the computer software arts.

Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

Input/output interface 230 represents electrical components and optional code that together provide an interface from the internal components of computing device 200 to external components. Examples include a driver integrated circuit with associated programming.

Communication interface 240 represents electrical components and optional code that together provides an interface from the internal components of computing device 200 to external networks. Communication interface 240 may be bi-directional, such that, for example, data may be sent from computing device 200, and instructions and updates may be received by computing device 200.

Bus 250 represents one or more interfaces between components within computing device 200. For example, bus 250 may include a dedicated connection between processor 210 and memory 220 as well as a shared connection between processor 210 and multiple other components of computing device 200.

As used herein, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and the drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. An apparatus for polarization state generation and phase control, comprising:
a Stokes Basis generator configured to generate a plurality of Stokes Bases from at least one input beam;
an intensity modulator configured to modulate an intensity of each of the Stokes Bases; and
a beam combiner configured to combine the modulated Stokes Bases into an output beam.

2. The apparatus of claim 1, wherein the plurality of Stokes Bases are at least four Stokes Bases beams.

3. The apparatus of claim 1, wherein the plurality of Stokes Bases are three or less Stokes Bases.

4. The apparatus of claim 1, wherein the Stokes Basis generator, the intensity modulator and the beam combiner are configurable such that the apparatus provides an output beam with a selected polarization state.

5. The apparatus of claim 1, wherein the Stokes Basis generator, the intensity modulator and the beam combiner are configurable such that the apparatus provides an output beam with a selected phase.

6. The apparatus of claim 1, wherein the Stokes Basis generator comprises at least one of a plurality of knife-edge reflectors, a fiber optic power splitter, or a plurality of bulk beam splitters.

7. The apparatus of claim 6, wherein the Stokes Basis generator further comprises a plurality of polarizers each corresponding to a respective one of the Stokes Bases.

8. The apparatus of claim 6, wherein the Stokes Basis generator further comprises a plurality of variable density filters each corresponding to a respective one of the Stokes Bases.

9. The apparatus of claim 1, wherein the intensity modulator comprises at least one of a reflective intensity modulator or a transmissive intensity modulator.

10. The apparatus of claim 1, wherein the intensity modulator comprises a digital micromirror device (DMD).

11. The apparatus of claim 10, wherein the DMD includes multiple regions, and a number of the regions of the DMD is equal to a number of Stokes Bases generated by the Stokes Basis generator.

12. The apparatus of claim 1, wherein the beam combiner comprises at least one of a fiber optic power splitter or a plurality of bulk beam splitters.

13. A method of polarization state generation and phase control, comprising:
generating a plurality of Stokes Bases from at least one input beam;
modulating an intensity of each of Stokes Bases; and
combining the modulated Stokes Bases into an output beam.

14. The method of claim 13, wherein generating the Stokes Bases comprises generating four or more Stokes Bases.

15. The method of claim 13, wherein generating the Stokes Bases comprises generating the Stokes Bases with substantially equal intensity.

16. The method of claim 13, wherein modulating the intensity of each of the Stokes Bases comprises determining an appropriate intensity of each of the Stokes Bases such that an error between a desired polarization state and a polarization state of the output beam is minimized.

17. The method of claim 13, wherein the output beam has a selected polarization state.

18. The method of claim 13, wherein the output beam has a selected phase.

19. The method of claim 13, wherein the Stokes Bases are coherent.

20. The method of claim 13, wherein a degree of mutual coherence between each pair of Stokes Bases is variable and can be tuned.
